(19) United States
(12) Patent Application Publication
(10) Pub. No.: US 2026/0365827 A1
(43) Pub. Date: Nov. 19, 2026

(54) SURFACE-TREATED CALCIUM CARBONATE FILLER, RESIN COMPOSITION USING THE SAME, AND MOLDED ARTICLE USING THE SAME

(71) Applicant: MARUO CALCIUM CO., LTD., Hyogo (JP)

(72) Inventors: Yusuke HAYASHI, Hyogo (JP); Makoto NAGAMATSU, Hyogo (JP); Hidemitsu KASAHARA, Hyogo (JP)

(21) Appl. No.: 19/145,984

(22) PCT Filed: Aug. 29, 2023
(86) PCT No.: PCT/JP2023/031097

§ 371 Date: Jul. 7, 2025

(30) Foreign Application Priority Data
May 30, 2023 (JP) 2023-089154

(51) Int. Cl. C08K 9/04; C08J 5/18; C09C 1/02; C09C 3/00; C09C 3/06; C09C 3/08

(52) U.S. Cl. CPC C08K 9/04; C08J 5/18; C09C 1/024; C09C 3/006; C09C 3/063; C09C 3/08; C01P 2004/51; C01P 2004/61; C01P 2006/12; C08J 2323/12; C08K 2201/005; C08K 2201/006

(57) ABSTRACT

A surface-treated calcium carbonate according to the present invention contains surface-treated calcium carbonate particles that have been surface-treated using fatty acids and phosphoric acids, the following formulae (a), (b), and (c) being satisfied:

3≤Sw≤20 (m²/g); (a)

300≤Pw≤5000 (ppm); and (b)

50≤Ca conversion rate≤95 (mass %), (c)
where the Sw is a BET specific surface area (m²/g) of the surface-treated calcium carbonate particles, the Pw is an elemental phosphorus content (ppm) in the surface-treated calcium carbonate particles measured using an inductively coupled plasma (ICP) emission spectrometer, and the Ca conversion rate is the percentage of the mass (g) of a fatty acid constituting fatty acid calcium relative to a total surface treatment amount (g) of the surface-treated calcium carbonate particles.

### TECHNICAL FIELD

The present invention relates to a surface-treated calcium carbonate filler, a resin composition using the same, and a molded article using the same, and more specifically to a surface-treated calcium carbonate filler capable of improving heat resistance of the obtained resin composition, a resin composition using the same, and a molded article using the same.

### BACKGROUND ART

Compositions made of synthetic resin such as polyolefin, polyester, polystyrene, or vinyl chloride have excellent rigidity, impact resistance, heat resistance, moldability, transparency, and chemical resistance, and thus are widely used for various applications such as various industrial materials, automobile-related parts, various containers such as medical containers and cosmetic containers, various films and fibers for daily necessities, industrial products, and the like, in combination with calcium carbonate inorganic pigments or the like.

These resin compositions contain inorganic fillers for various purposes such as imparting thermal stability, abrasion resistance, rigidity, impact resistance, and thixotropic properties. Here, an inorganic filler needs to be sufficiently dispersed in a resin composition in order for a resin product containing the inorganic filler to exhibit desired properties. Therefore, various improvements have been made to kneading machines and kneading conditions, and various surface treatments have been applied to inorganic fillers to improve their dispersibility in resin compositions, and surface treatment agents and surface treatment methods for use in the surface treatments have been studied.

For example, a porous film produced from a polyolefin-based resin composition is produced by forming the polyolefin-based resin composition into films and drawing the resulting films, and forming voids at the interface between the resin and the filler using differences in mechanical properties between the polyolefin-based resin and the inorganic filler. Such porous films have been researched and developed for a wide variety of uses such as synthetic paper, sanitary materials, medical materials, building materials, agricultural permeable sheets, battery separators, and the like, and some of which have been put into practical use. However, in order to obtain more highly functional films, it is required that there be little variation in the size of voids formed in the films and that the distribution of voids within the film surfaces be uniform. Furthermore, porous films tend to have poor heat resistance due to having a structure with many voids formed through drawing according to a production method therefor, and thus there is a demand for improvement in their heat resistance.

As described above, it is extremely important to uniformly disperse inorganic filler in a resin composition. However, if only a mechanical means is used for such dispersion, even if a certain degree of dispersion is achieved, the production cost will increase, resin will deteriorate, and the resin will decompose and generate gas and dust, which may cause the problem of deterioration of a working environment. Also, when a resin composition has insufficient heat resistance, during a kneading or extrusion operation, scorching between the resin and/or a surface treatment agent remaining in the resin composition, and an inorganic filler occurs, which forms aggregates (burnt resin), resulting in clogging of a strainer installed inside a die of an extruder. In film applications, strainers with fine meshes are used and are particularly likely to become clogged. Replacement of a strainer not only requires manpower but also results in loss of a resin composition used, loss of time taken for production, and the like, resulting in a significant increase in costs.

In order to solve these problems, conventionally, metal soaps such as calcium stearate, phenolic antioxidants, and phosphorus antioxidants have been added to these resins to increase the stability of the resulting resin compositions. Also, the addition of calcium carbonate treated with fatty acids such as stearic acid and stearic acid soap has provided calcium carbonate with the function of increasing the stability of the resulting resin composition.

Patent Document 1 describes an inorganic filler whose dispersibility in a resin composition is improved by performing surface treatment on inorganic particles in a combination of a surfactant and a chelating agent for further improvement. Patent Documents 2 and 3 describe that aggregates are removed by further combining operations such as classification.

All of the techniques described in Patent Documents 1 to 3 improve the dispersibility of surface-treated calcium carbonate. However, on the other hand, in the production of such an inorganic filler, a reaction between fatty acids and calcium ions is also prevented because a compound having a chelating ability captures calcium ions. As a result, the proportion of calcium salt of a generated fatty acid will decrease, and the proportion of remaining fatty acids will increase.

Such a fatty acid and alkali metal salts of the fatty acid are thermally unstable, compared to calcium salts of the fatty acid. As a result, a polyolefin-based resin composition produced using such surface-treated calcium carbonate may not have sufficient heat resistance or durability.

Also, it is possible to stabilize a resin composition obtained by adding, to such a resin, a phenolic antioxidant and a phosphorus antioxidant. However, it has been pointed out that because very small amounts of these antioxidants are added, it is difficult to uniformly distribute the antioxidants throughout the resin, resulting in local concentration unevenness.

In recent years, polyolefin-based resins have come to be known as relatively environmentally friendly resins, and are expected to be used as base materials for applications in green infrastructure. Meanwhile, as described above, it has been pointed out that polyolefin-based resins have insufficient thermal stability, and thus there is a growing demand for greater heat resistance and durability.

### RELATED ART DOCUMENTS

### Patent Documents

[Patent Document 1] Japanese Laid-Open Patent Publication No. 2002-363443
[Patent Document 2] Japanese Laid-Open Patent Publication No. 2006-169421
[Patent Document 3] WO 2007/088707

### SUMMARY OF INVENTION

### Problem to be Solved by the Invention

The present invention aims to solve the above problems, and provide a surface-treated calcium carbonate filler that can be dispersed substantially uniformly in a resin composition and impart high thermal stability to the resin composition, a resin composition using the same, and a molded article using the same.

### Means for Solving the Problem

The present invention is a surface-treated calcium carbonate filler comprising surface-treated calcium carbonate particles that have been surface-treated using fatty acids and phosphoric acids, formulae (a), (b), and (c) below being satisfied:

3≤Sw≤20 (m²/g); (a)

300≤Pw≤5000 (ppm); and (b)

50≤Ca conversion rate≤95 (mass %), (c)
where the Sw is a BET specific surface area (m²/g) of the surface-treated calcium carbonate particles,
the Pw is an elemental phosphorus content (ppm) in the surface-treated calcium carbonate particles measured using an inductively coupled plasma (ICP) emission spectrometer, and
the Ca conversion rate is a percentage of the mass (g) of a fatty acid constituting fatty acid calcium relative to a total surface treatment amount (g) of the surface-treated calcium carbonate particles.

In one embodiment, the surface-treated calcium carbonate filler further satisfies formulae (d), (e), and (f) below:

0.1≤D50≤1.5 (μm); (d)

0.9≤(D90−D10)/D50≤2.0; and (e)

Da≤5.0 (μm), (f)
where D50 is a 50% diameter (μm) cumulated from a small particle side in a volume particle size distribution of the surface-treated calcium carbonate particles measured using a laser diffraction particle size distribution analyzer,
D90 is a 90% diameter (μm) cumulated from the small particle side in the volume particle size distribution of the surface-treated calcium carbonate particles measured using the laser diffraction particle size distribution analyzer,
D10 is a 10% diameter (μm) cumulated from the small particle side in the volume particle size distribution of the surface-treated calcium carbonate particles measured using the laser diffraction particle size distribution analyzer, and
Da is the maximum particle diameter (μm) in the volume particle size distribution of the surface-treated calcium carbonate particles measured using the laser diffraction particle size distribution analyzer.

In one embodiment, the fatty acids are at least one compound selected from the group consisting of saturated fatty acids and saturated fatty acid salts.

In one embodiment, the surface-treated calcium carbonate filler of the present invention is used to form a polyolefin-based resin composition.

The present invention is also a resin composition comprising a resin, and the above surface-treated calcium carbonate filler.

In one embodiment, the resin is a polyolefin-based resin.

The present invention is also a molded article comprising the above resin composition.

In one embodiment, the molded article has a film form.

### Effects of the Invention

According to the present invention, the surface-treated calcium carbonate filler has good dispersibility in a resin composition and has high heat resistance. As a result, a resin composition containing a surface-treated calcium carbonate filler according to the present invention, for example, suppresses scorching occurring between the filler and the resin or a remaining surface treatment agent during kneading or extrusion operations, and also prevents or reduces clogging of a strainer attached inside the die of an extruder. Furthermore, the resin composition obtained in this manner also has high heat resistance.

### DESCRIPTION OF EMBODIMENTS

### 1. Surface-Treated Calcium Carbonate Filler

A surface-treated calcium carbonate filler according to the present invention contains surface-treated calcium carbonate particles, and is preferably constituted by the surface-treated calcium carbonate particles as a main component.

### (a) BET Specific Surface Area (Sw)

In the present invention, the surface-treated calcium carbonate particles have a predetermined BET specific surface area (Sw; m²/g) measured using the nitrogen adsorption method. In the present invention, the Sw of the surface-treated calcium carbonate particles satisfies 3≤Sw≤20 (m²/g), and preferably satisfies 4≤Sw≤16 (m²/g), and more preferably satisfies 5≤Sw≤12 (m²/g). When the Sw of surface-treated calcium carbonate particles is less than 3 (m²/g), their primary particles will be excessively large, which causes a decrease in the strength of a resin composition when such particles are blended into the resin composition. Also, when the Sw of the surface-treated calcium carbonate particles exceeds 20 (m²/g), uniform dispersion of the surface-treated calcium carbonate particles in a resin composition will be difficult.

### Method for Measuring Sw

The Sw of the surface-treated calcium carbonate particles can be measured as follows using a Macsorb HM model-1201 manufactured by Mountech Co., Ltd., for example.

Specifically, the Sw is measured as follows: 0.2 to 0.3 g of a surface-treated calcium carbonate filler to be used for measurement is set in a measuring device, heat treatment is performed as a pretreatment, at 200 °C for 10 minutes in a mixed gas atmosphere of nitrogen and helium, and low-temperature and low-humidity physical adsorption is performed in a liquid nitrogen environment.

The Sw can be controlled by varying various conditions when surface-treated calcium carbonate particles that constitute the filler according to the present invention are produced. Examples of conditions under which the Sw can be controlled in the above range include the concentration of milk of lime used in a later-described carbonation reaction, the temperature used for the carbonation reaction, the concentration of carbon dioxide gas used, the types of additives used in the carbonation reaction, and combinations thereof. If such conditions are insufficiently set, it may be difficult to obtain surface-treated calcium carbonate particles that satisfy the above range of Sw.

### (b) Phosphorus Element Content (Pw) Measured Using Inductively Coupled Plasma (ICP) Emission Spectrometer

In the present invention, the surface-treated calcium carbonate particles have a predetermined phosphorus content (Pw; ppm) measured using an ICP emission spectrometer. In the present invention, the Pw of the surface-treated calcium carbonate particles satisfies 300≤Pw≤5000 (ppm), preferably satisfies 400≤Pw≤3500 (ppm), and more preferably satisfies 500≤Pw≤2000 (ppm). When the Pw is lower than 300 (ppm), the particles have insufficient heat resistance. When the Pw is greater than 5000 (ppm), the heat resistance of the particles cannot be improved any further, and instead, a large amount of phosphorus will be contained in waste water during dehydration performed in the production of such surface-treated calcium carbonate particles, resulting in an excessive burden on waste water treatment facilities.

### Method for Measuring Pw

The Pw can be measured as follows using an ICP emission spectrometer SPS3500 manufactured by SII Nano Technology, for example.
(1) First, 1.0 g of a surface-treated calcium carbonate filler to be used for measurement is placed in a crucible and calcined at 300 °C for 3 hours in an electric furnace.
(2) After the calcination, about 60 mL of distilled water and 7.5 mL of 1.38 N nitric acid (nitric acid (1.38) for measuring toxic metals manufactured by Fujifilm Wako Pure Chemical Corporation) are placed in a beaker, and the resulting mixture is boiled on an electric stove and slowly cooled.
(3) The cooled mixture is added to a 100 mL-volumetric flask containing 100 μg of yttrium, and the volumetric flask is filled up to 100 mL with distilled water.
(4) Then, a sample for ICP measurement is prepared from a filtrate obtained by filtration through 5C filter paper.
(5) Thereafter, this sample is used to measure the phosphorus content (ppm) contained in the sample using the above ICP emission spectrometer.

### (c) Ca Conversion Rate

In the present invention, the surface-treated calcium carbonate particles satisfy a predetermined Ca conversion rate. Here, the term “Ca conversion rate” as used herein refers to the percentage of the mass (g) of a fatty acid constituting fatty acid calcium relative to the total surface treatment amount of surface-treated calcium carbonate particles. In the present invention, the Ca conversion rate of the surface-treated calcium carbonate particles satisfies 50≤Ca conversion rate≤95 (mass %), preferably satisfies 55≤Ca conversion rate≤85 (mass %), and more preferably satisfies 60≤Ca conversion rate 80 (mass %). If the Ca conversion rate of the surface-treated calcium carbonate particles is less than 50 mass %, surface-treated calcium carbonate particles having required heat resistance cannot be obtained, which may cause burnt resin where the resin and/or a surface treatment agent remaining in the resin composition, and an inorganic filler may burn during kneading or extrusion operation. If the Ca conversion rate of the surface-treated calcium carbonate particles exceeds 95 mass %, the dispersibility of the surface-treated calcium carbonate particles in the resin composition may decrease.

### Method for Measuring Ca Conversion Rate

The Ca conversion rate can be measured using an ordinary extraction method. Specifically, among surface treatment agents that can be used to obtain surface-treated calcium carbonate particles, fatty acid calcium is insoluble in a 95 mass % ethanol solvent, whereas fatty acids and alkali metal salts of fatty acids are soluble in a 95 mass % ethanol solvent. As a result, the Ca conversion rate of the surface-treated calcium carbonate particles can be measured as follows utilizing such a difference in solubility.
(1) First, 5.0 g of surface-treated calcium carbonate particles and 80 g of 95 mass % ethanol are added to a 300-mL Erlenmeyer flask.
(2) Then, a surface treatment agent remaining in the surface-treated calcium carbonate particles is extracted by immersing the Erlenmeyer flask in a water bath at 90 °C or higher and performing reflux for 1 hour.
(3) The Erlenmeyer flask is sufficiently cooled to 20 °C, and then the content in the Erlenmeyer flask is subjected to suction filtration through a Teflon (registered trademark) filter with a pore size of 0.5 μm or less.
(4) The obtained filtrate is placed in a dry and quantitatively determined 200-mL beaker, and dried through evaporation on a water bath at 90 °C or higher to remove the solvent. The mass of the resulting residue is measured (the mass of the residue corresponds to the total amount of fatty acids and alkali metal salts of fatty acids in the surface treatment agent remaining on the surface-treated calcium carbonate particles).
(5) The mass obtained in (4) above is the mass of fatty acids and alkali metal salts of fatty acids in the surface treatment agent in 5.0 g of the surface-treated calcium carbonate particles. Therefore, the content of the fatty acids and the alkali metal salts of the fatty acids in the surface treatment in 1.0 g of the surface-treated calcium carbonate particles can be calculated as mass % (X) by multiplying this value by ⅕. Note that this (X) is a numerical value that includes the mass of alkali metal elements derived from alkali metal salts of fatty acids, and the like. Therefore, in order to calculate the mass % of fatty acids and fatty acids derived from alkali metal salts of fatty acids, the content of alkali metal elements (mass %; Y) contained in the surface-treated calcium carbonate particles is subtracted through atomic absorption spectrometry.
(6) The percentage of the mass (g) of fatty acids that constitute fatty acid calcium to the total surface treatment amount (g) of the surface-treated calcium carbonate particles (i.e., Ca conversion rate) is calculated using the following formula, and X (mass %), Y (mass %), and thermal reduction TG (mass %) per gram of calcium carbonate from 200 °C to 500 °C:

Ca conversion rate (mass %)={(Tg (mass %)−(X (mass %)−Y (mass %))}/TG (mass %)×100

Here, the content (mass %; Y) of the alkali metal elements contained in the surface-treated calcium carbonate particles is measured as follows.

### Method for Measuring Alkali Metals Through Atomic Absorption Spectrometry

In a crucible, 1.0 g of the surface-treated calcium carbonate particles is weighed, placed in a muffle furnace (NMF-120 manufactured by Masuda Corporation), calcined at 300 °C for 2 hours, and cooled to room temperature in a desiccator. Then, a sample is placed in a 200-mL beaker, and 60 mL of distilled water is poured into the beaker. Then, 7.5 mL of 1.38 N nitric acid (for toxic metal measurement, nitric acid (1.38), manufactured by Fujifilm Wako Pure Chemical Corporation) is introduced into the beaker, the beaker is covered with a watch glass, and the mixture is boiled using an electric heater. A measurement sample is prepared by cooling the resulting mixture at room temperature, introduced into a 100-mL volumetric flask, and filling up the volumetric flask to 100 mL with distilled water. The content of alkali metal elements (mass %; Y) is measured using the measurement sample obtained in this manner by an atomic absorption spectrophotometer (AA-6700F manufactured by Shimadzu Corporation).

Also, the thermal reduction TG (mass %) per gram of calcium carbonate from 200 °C to 500 °C used to calculate the above Ca conversion rate is measured as follows.

### Method for Measuring TG

About 30 mg of surface-treated calcium carbonate particles is weighed in a platinum sample pan, and then the thermal reduction of the particles when the temperature is raised from 200 °C to 500 °C at a temperature increase rate of 30 °C/min is measured using, for example, a differential thermal analyzer (DTG-60A manufactured by Shimadzu Corporation). As a result, the thermal reduction TG (mass %) per gram of surface-treated calcium carbonate is measured.

The Ca conversion rate can be adjusted by controlling the temperature history in a surface treatment step and a drying step when surface-treated calcium carbonate particles that constitute a filler according to the present invention are produced. The temperature history includes the temperatures employed in the surface treatment step and the drying step, and a time period in which a sample is exposed to a temperature, for example. Specific examples of the temperature history include the temperature of an aqueous calcium carbonate slurry used when synthetic calcium carbonate obtained using a wet carbonation method or the like is subjected to surface treatment using surface treatment agents (fatty acids and phosphoric acids), and the time taken for the surface treatment; the temperature when the surface treatment agents and calcium carbonate are bonded (surface treatment) and the time taken for the surface treatment; the temperature and dehydration time required for dehydration after surface treatment; the time taken for the subsequent drying step and the drying time; and combinations thereof. If a conductive heat transfer dryer is, for example, selected when surface-treated calcium carbonate particles are produced, it will take a longer time to dry the particles than an instant dryer such as a spray dryer. However, if the Ca conversion rate is insufficient during surface treatment, it may be possible to increase the Ca conversion rate by adjusting the drying temperature and the drying time. If the Ca conversion rate is insufficient during surface treatment and a sufficient drying time cannot also be maintained, it may be difficult to obtain surface-treated calcium carbonate particles that satisfy the above Ca conversion rate range.

The surface-treated calcium carbonate particles contained in the surface-treated calcium carbonate filler according to the present invention preferably satisfy one or more of the following (d), (e), and (f) in addition to the above (a) to (c), and more preferably satisfy all of the (d), (e), and (f).

(d) 50% Diameter (D50) Cumulated from Small Particle Side in Volume Particle Size Distribution

In the present invention, surface-treated calcium carbonate particles preferably have a 50% diameter (D50; μm) cumulated from the small particle side within a predetermined range in a volume particle size distribution measured using a laser diffraction particle size distribution analyzer. In the present invention, the D50 of the surface-treated calcium carbonate particles preferably satisfies 0.1≤D50≤1.5 (μm), more preferably satisfies 0.2≤D50≤1.2 (μm), and even more preferably satisfies 0.3≤D50≤0.8 (μm). Although it is technically possible to obtain surface-treated calcium carbonate particles with a D50 of less than 0.1 (μm), more advanced and precise technology is required which may increase production costs. When the D50 exceeds 1.5 μm, the strainer may be more likely to be clogged.

### Method for Measuring D50

The D50 can be measured using, for example, a laser diffraction particle size distribution analyzer (MT-3300EX II manufactured by MicrotracBEL Corp.) as follows together with the D10, the D90, and the Da, which will be described later.
(1) First, 0.3 g of a surface-treated calcium carbonate particle sample and 50 mL of a medium are added to a 100-mL beaker.
(2) Then, the content in the beaker is dispersed by irradiating the content with ultrasonic waves at 300 μA for 60 seconds using, for example, an ultrasonic dispersion machine US-300T manufactured by Nihonseiki Kaisha Ltd.
(3) Thereafter, the volume particle size distribution of the surface-treated calcium carbonate particles in the sample is measured using the laser diffraction particle size distribution analyzer (MT-3300EX II manufactured by MicrotracBEL Corp.).

Note that examples of a medium that can be used in the above measurement include methanol, ethanol, and combinations thereof.

The D50 can be controlled by varying various conditions under which surface-treated calcium carbonate particles that constitute the filler according to the present invention are produced. Conventionally, various methods for dispersing calcium carbonate particles are known. Examples thereof include a method for reducing the D50 by finely crushing particles using a mechanical method such as a ball mill, a sand grinder mill, an impact mill, a homogenizer, or a DYNO mill. However, in a wet carbonation method, it is preferable to use Ostwald ripening, which involves growth of the particles to a certain particle size and dispersion of the resulting particles, as a method for controlling the particle size of the calcium carbonate particles.

### (e) Sharpness Index of Volume Particle Size Distribution ((D90−D10)/D50)

In the present invention, the surface-treated calcium carbonate particles preferably have a sharpness index ((D90−D10)/D50) within a predetermined range in the volume particle size distribution measured using the laser diffraction particle size distribution analyzer. Here, the D50 is as described above, the D90 is a 90% diameter (μm) cumulated from the small particle side in the volume particle size distribution measured using the laser diffraction particle size distribution analyzer, the D10 is the 10% diameter (μm) cumulated from the small particle side in the volume particle size distribution measured using the laser diffraction particle size distribution analyzer, and the Da is the maximum particle diameter (μm) in the volume particle size distribution measured using the laser diffraction particle size distribution analyzer. In the present invention, the sharpness index ((D90−D10)/D50) of the surface-treated calcium carbonate particles preferably satisfies 0.9≤(D90−D10)/D50≤2.0, and more preferably satisfies 1.0≤(D90−D10)/D50≤1.6. Although it is technically possible to obtain surface-treated calcium carbonate particles having a sharpness index of less than 0.9, more advanced and precise technology is required which may increase production costs. If the sharpness index of the surface-treated calcium carbonate particles exceeds 2.0, there will be a large variation in the size of voids formed in a molded article (e.g., films) obtained by kneading the resulting surface-treated calcium carbonate filler and a resin, which may result in it being difficult to obtain a porous film with a uniform in plane void distribution.

### Method for Measuring Sharpness Index ((D90−D10)/D50)

The D10, the D90, and the Da, which constitute the sharpness index, can be measured using the laser diffraction particle size distribution analyzer (MT-3300EX II manufactured by MicrotracBEL Corp.) described for measuring the D50, in the same manner as in the measurement of the D50, for example.

The sharpness index can be controlled by varying various conditions under which surface-treated calcium carbonate particles that constitute the filler according to the present invention are produced. Examples of the method for reducing the sharpness index of calcium carbonate particles (e.g., sharpening the particle size distribution by reducing the number of coarse particles and fine particles) include the above-mentioned mechanical method using a ball mill, a sand grinder mill, an impact mill, a homogenizer, or a DYNO mill, and a method for separating fine particles from coarse particles, such as elutriation, which utilizes the difference in a settling velocity of particles in water depending on the particle size. However, it is preferable to use Ostwald ripening, from the viewpoint of making it easier to reduce the sharpness index due to an increase in the uniformity of the particle diameter of the calcium carbonate particles.

### (f) the Maximum Particle Diameter (Da) in Volume Particle Size Distribution

In the present invention, the surface-treated calcium carbonate particles preferably have the maximum particle diameter (Da) within a predetermined range in the volume particle size distribution measured using the laser diffraction particle size distribution analyzer. In the present invention, the Da of the surface-treated calcium carbonate particles preferably satisfies Da≤5.0 (μm) (i.e., 0<Da≤5.0 (μm)), and more preferably satisfies Da≤4.0 (μm) (i.e., 0<Da≤4.0 (μm)). When the Da exceeds 5.0 μm, the resulting surface-treated calcium carbonate filler and a resin may not be sufficiently dispersed during kneading, and the strainer may be more likely to be clogged, for example.

### Method for Measuring Da

The Da can be measured using the laser diffraction particle size distribution analyzer (MT-3300EX II manufactured by MicrotracBEL Corp.) described for measuring the D50 in the same manner as in the measurement of the D50.

The Da can be controlled by varying various conditions under which the surface-treated calcium carbonate particles that constitute the filler according to the present invention are produced. Preferably, methods for reducing the maximum particle diameter (Da) in the volume particle size distribution include classification utilizing gravity, centrifugal force, flotation, or the like, such as decantation, and removal of impurities and coarse particles using a sieve, filter, or the like for the purpose of removing impurities and coarse particles in the form of water slurry, and removal of aggregates generated through drying, by performing classification operations such as air classification while the classification target is in the form of a powder.

Surface-Treated Calcium Carbonate Particles that have been Surface-Treated with Surface Treatment Agent

As described above, the surface-treated calcium carbonate particles contained in the surface-treated calcium carbonate filler according to the present invention satisfy all of formulae (a), (b), and (c), and satisfy (d), (e), and (f) as needed. Such surface-treated calcium carbonate particles have been surface-treated with a surface treatment agent. Note that the term “surface-treated” as used herein is used to indicate the “state” of the surface of a surface-treated calcium carbonate particle. On the other hand, the terms “to be surface-treated/subjected to surface treatment” as used herein mean that the surfaces of calcium carbonate particles not subjected to surface-treatment (i.e., before surface treatment) have undergone a process of modification (surface treatment), and are clearly distinguished from the above-mentioned “surface-treated”.

The surface-treated calcium carbonate particles in the present invention are particles obtained by surface-treating unmodified (before surface treatment) calcium carbonate particles using a surface treatment agent.

Here, from the viewpoint of degassing properties when being kneaded with a resin, unmodified calcium carbonate particles are particles of synthetic calcium carbonate (e.g., light colloidal calcium carbonate) that can be controlled uniformly, rather than particles of natural calcium carbonate (e.g., heavy calcium carbonate) that contain many fine particles. From the viewpoint of crystal stability, a preferable crystal form is a crystal form in which calcite is contained as a main component, and colloidal calcium carbonate is particularly preferable because colloidal calcium carbonate contains a small number of fine particles and coarse particles and its particle uniformity is comparatively maintained.

Also, in order to further improve the uniformity of the synthetic calcium carbonate particles, the calcium carbonate particles may be obtained by separating a light liquid (fine particle side) and a heavy liquid from a water slurry used to obtain the synthetic calcium carbonate particles or a water slurry containing calcium hydroxide of the synthetic calcium carbonate particles that are to be produced, at an appropriate ratio using a separation device such as a hydrocyclone.

The above surface treatment agent contains fatty acids and phosphoric acids as main components.

Fatty acids that may be contained in the surface treatment agent have the ability to form fatty acid calcium through a substitution reaction on at least some of or preferably all of the surfaces of the unmodified calcium carbonate particles, and to modify the surfaces of the calcium carbonate particles.

Examples of fatty acids include fatty acids, fatty acid salts, and combinations thereof.

Examples of fatty acids include saturated fatty acids, unsaturated fatty acids, alicyclic carboxylic acids, and combinations thereof.

Examples of the saturated fatty acids include capric acid, lauric acid, myristic acid, palmitic acid, and stearic acid, and combinations thereof. Examples of the unsaturated fatty acids include oleic acid, linoleic acid, and linolenic acid, and combinations thereof. Examples of the alicyclic carboxylic acids include naphthenic acid having a carboxyl group at an end of a cyclopentane ring or a cyclohexane ring.

Examples of fatty acid salts include alkali metal salts (e.g., sodium salts and potassium salts), alkaline earth metal salts (e.g., calcium salts and magnesium salts), ammonium salts, and amine salts of the above fatty acids, and combinations thereof. It is most preferable to use alkali metal salts of fatty acids because alkali metal salts have high solubility in water and facilitate treatment of the surface of calcium carbonate.

Examples of fatty acid salts include saturated fatty acids such as potassium laurate, potassium myristate, potassium palmitate, sodium palmitate, potassium stearate, and sodium stearate; unsaturated fatty acid salts such as potassium oleate and sodium oleate, and alicyclic carboxylic acid salts such as lead naphthenate and lead cyclohexylbutyrate, and combinations thereof.

The fatty acids mentioned above may be modified or unmodified fatty acids originating from an animal or a plant, for example. Examples of the fatty acids include mixed fatty acids such as beef tallow fatty acids, palm oil fatty acids, palm kernel oil fatty acids, and soybean oil fatty acids, which are generally used in the technical field; alkali metal salts thereof, or alternatively, may include so-called hydrogenated mixed fatty acids, which have been subjected to hydrogenation to reduce the degree of unsaturation of these mixed fatty acids, and alkali metal salts thereof.

Note that, when a fatty acid is directly used as a type of fatty acid, in order to enable more uniform surface treatment of unmodified calcium carbonate particles, it is preferable that the fatty acid is pre-dissolved in hot water heated to a temperature higher than the melting point of the fatty acid to be used, a known emulsifier such as an anionic surfactant or a nonionic surfactant is added thereto as appropriate, the fatty acid is emulsified using an emulsifying disperser such as a homo-mixer or a homogenizer, and added to the unmodified calcium carbonate.

Also, among the above-mentioned fatty acids, unsaturated fatty acids not only have high solubility in water but also have low melting points, and thus the surfaces of the unmodified calcium carbonate particles can be more easily uniformly treated. However, from the viewpoint of heat resistance, unsaturated fatty acids are susceptible to thermal deterioration due to the presence of unsaturated double bonds. Therefore, in the present invention, it is preferable that fatty acids are preferably saturated fatty acids and/or saturated fatty acid salts because concerns about heat deterioration, such as those of the above-mentioned fatty acids, are eliminated in advance. Alternatively, the total amount of saturated fatty acids and saturated fatty acid salts is preferably 90 mass % or more, and more preferably 100 mass %, with respect to the total mass of the fatty acids.

Note that the proportion of fatty acids present in the surface-treated calcium carbonate filler according to the present invention can be easily measured as follows, for example, through gas chromatography performed on the filler.
(1) First, 1.0 mg of a sample of surface-treated calcium carbonate particles contained as a surface-treated calcium carbonate filler, and 10 μmL of tetramethylammonium hydroxide (10 mass % methanol solution) serving as an esterifying agent are weighed out into a sample cell, and pyrolyzed at 300 °C for 30 seconds and vaporized using a pyrolysis device (Multi-Shot Pyrolyzer MODEL EGA/PY-3030D manufactured by Frontier Laboratories Ltd.), for example.
(2) Then, the composition of fatty acids can be analyzed using the vaporized components under the following conditions using a gas chromatography mass spectrometer (GCMS-QP2010Ultra manufactured by Shimadzu Corporation):

### Gas Chromatography Conditions

Vaporization chamber temperature: 250 °C.
Column used: Rtx-5 MS column (length of 30 m, membrane pressure of 0.25 μm, inner diameter of 0.25 mmD)
Column conditions: temperature increase rate is 10 °C/min, 40 °C to 300 °C, 300 °C held for 10 minutes
Carrier gas: He,
Pressure: 80 KPa,
Total flow rate: 76.5 mL/min
Column flow rate: 1.5 mL/min,
Split ratio: 46.

### Mass Spectrometry Conditions

Ion source temperature: 230 °C.
Interface temperature: 250 °C.
Solvent elution time: 1.5 minutes.

Examples of phosphoric acids that can be contained in the surface treatment agent include inorganic phosphoric acids and organic phosphoric acids, and combinations thereof.

Examples of the inorganic phosphoric acids include phosphorous acid, phosphinic acid, orthophosphoric acid, pyrophosphoric acid, polyphosphoric acid, and condensed phosphoric acid, and salts thereof (e.g., alkali metal salts such as sodium salts and potassium salts; alkaline earth metal salts such as magnesium salts; and aluminum salts), and combinations thereof. Examples of the organic phosphoric acids include phosphonic acid, phosphoric acid esters, acidic phosphoric acid esters, and salts thereof (e.g., alkali metal salts such as sodium salts and potassium salts; alkaline earth metal salts such as magnesium salts; and aluminum salts), and combinations thereof.

In the present invention, phosphoric acids are preferably compounds with the ability to chelate calcium ions.

In general, when an appropriate amount of, for example, an alkali metal salt of a fatty acid is dissolved as a surface treatment agent in a water slurry of calcium carbonate particles, a part of the alkali metal salt thereof reacts with calcium ions that have already been eluted from the calcium carbonate particles into the water slurry, thus producing a free calcium salt of the fatty acid. The free calcium salt of the fatty acid does not contribute to surface treatment to be performed on calcium carbonate particles, thus resulting in insufficient surface treatment performed on calcium carbonate.

In contrast, when a compound having a chelating ability is added as phosphoric acids to the water slurry, the compound preferentially captures calcium ions and impairs the generation of the above-mentioned free calcium salt of the fatty acid. As a result, it can be expected that most of the alkali metal salt of the fatty acid contributes to surface treatment performed on calcium carbonate particles, and the heat resistance of the surface-treated calcium carbonate particles obtained using a reduced amount of the alkali metal salt of the fatty acid added is improved. Also, because surfaces of calcium carbonate particles can be more uniformly treated, it can be expected that the dispersibility of the surface-treated calcium carbonate particles to be obtained will be improved.

Because the capturing of calcium ions as described above impairs the production of calcium salts of fatty acids, the proportion of fatty acids and alkali metal salts of fatty acids having poor heat resistance increases, that is, the Ca conversion rate decreases. However, the proportion of fatty acid calcium having higher heat resistance can be increased by improving the reduced Ca conversion rate by adding sufficient heat during surface treatment or a drying step or extending the time thereof.

Examples of phosphoric acids having such a chelating ability include inorganic condensed phosphates such as sodium hexametaphosphate, sodium polyphosphate, sodium pyrophosphate, and sodium ultraphosphate, and acidic phosphoric acid esters, and combinations thereof.

Here, the chelating ability of phosphoric acids can be expressed using the chelation value (C.V.) according to the Dow Chemical method. In the present invention, the chelation value of the phosphoric acids is preferably 50 mg CaCO₃/g≤chelation value, and more preferably 100 mg CaCO/g≤chelation value=500 mg CaCO₃/g. When the chelation value of the phosphoric acids is less than 50 mg CaCO₃, it may be difficult to uniformly treat the surfaces of unmodified calcium carbonate particles. When the chelation value of phosphoric acids is more than 500 mg CaCO₃/g, only a small amount of phosphoric acids is required to enclose calcium ions contained in the unmodified calcium carbonate particles, but the amount of the phosphorus element contained in the surface-treated calcium carbonate particles related to the above Pw may become insufficient, making it difficult to obtain desired heat resistance.

In the present invention, the surface treatment agent may contain other surface treatment agents to an extent that the efficacy of the resulting surface-treated calcium carbonate particles is not impaired. Examples of the other surface treatment agents include aromatic sulfonic acids and salts thereof or esters thereof, resin acids and salts thereof or esters thereof, and surfactants such as alcoholic surfactants, sorbitan fatty acid esters, amide-based surfactants, amine-based surfactants, polyoxyalkylene alkyl ethers, polyoxyethylene nonylphenyl ether, sodium alpha olefin sulfonate, long chain alkyl amino acids, amine oxides, alkyl amines, and quaternary ammonium salts; and combinations thereof.

### Surface Treatment to be Performed on Unmodified Calcium Carbonate Particles

The surface treatment for unmodified calcium carbonate particles using the above surface treatment agents is performed as follows, for example.

The fatty acids and phosphoric acids serving as the surface treatment, and other optional surface treatment agents are added to a water slurry containing unmodified calcium carbonate particles. Such a method is generally referred to as wet treatment, and is preferable in that the wet treatment can achieve both a suitable degree of surface treatment and production efficiency for calcium carbonate particles.

The amount of fatty acids used can be varied depending on the BET specific surface area of the calcium carbonate particles not yet subjected to surface treatment, i.e., so-called unmodified calcium carbonate particles. It is preferable to increase the amount of fatty acids used as the BET specific surface area of unmodified calcium carbonate particles increases, for example. The amount of fatty acids used is preferably 0.1 parts by mass or more and 10 parts by mass or less with respect to 100 parts by mass of unmodified calcium carbonate particles. When the amount of fatty acids used is less than 0.1 parts by mass, it may be difficult to disperse the fatty acids more uniformly in the unmodified calcium carbonate particles. When the amount of fatty acids used exceeds 10 parts by mass, bleeding may occur on the surface of a molded article produced using a resin composition obtained by kneading the resulting surface-treated calcium carbonate filler and a resin, and the strength of the resulting molded article may decrease, and it may also be difficult for the Ca conversion rate to exceed 50 mass %.

There is no particular limitation on the amount of phosphoric acids used because the amount of phosphoric acids used varies depending on the BET specific surface area and/or the amount of unmodified calcium carbonate particles, the amount of elemental phosphorus contained in the phosphoric acids, the type of resin to be kneaded last, kneading conditions, and the like. The amount of phosphoric acids used may be selected as appropriate by those skilled in the art so as to satisfy the above range of Pw.

There is no particular limitation on the order in which unmodified calcium carbonate particles are treated with the above fatty acids and the phosphoric acids. The unmodified calcium carbonate particles may first be treated with fatty acids and then treated with phosphoric acids, for example. Alternatively, unmodified calcium carbonate particles may first be treated with phosphoric acids and then treated with fatty acids. Alternatively, unmodified calcium carbonate particles may be treated with fatty acids and phosphoric acids together, i.e., simultaneously.

In the present invention, it is preferable to perform treatment by adding fatty acids and phosphoric acids simultaneously to unmodified calcium carbonate particles because it is possible to make the surface state of the resulting surface-treated calcium carbonate particles more uniform and to impart excellent dispersibility thereto. Alternatively, it is most preferable to perform treatment with phosphoric acids and then perform treatment with fatty acids because the capturing of calcium ions in the water slurry makes it possible to make the surface treatment state of calcium carbonate particles more uniform and to impart excellent dispersibility thereto.

Regarding the surface treatment temperature in the case of surface treatment in a water slurry, it is preferable to perform surface treatment at a temperature equal to or higher than the melting point of fatty acids used as a surface treatment agent. If the surface treatment temperature is lower than the melting point of fatty acids, there may be cases where the surface treatment performed on calcium carbonate particles is not uniform in addition to the Ca conversion rate excessively decreasing. On the other hand, when the surface treatment temperature exceeds the melting point of fatty acids, not only the uniformity of the surface treatment and the Ca conversion rate increase, but also the surface treatment can be performed in a short period of time.

In one embodiment, the surface treatment temperature is a temperature obtained by adding, to the melting point of fatty acids used, preferably 0 °C to 70 °C, more preferably 10 °C to 60 °C, and even more preferably 20 °C to 50 °C.

In one embodiment, the surface treatment temperature is preferably 20 °C to 98 °C, more preferably 40 °C to 90 °C, and even more preferably 60 °C to 80 °C.

The particles obtained after the surface treatment may be pulverized through any operation such as dehydration, drying, or pulverization, for example, according to a conventional method, for example.

Note that, in the present invention, even when the surface treatment is insufficiently performed thermally and/or temporally, when a dehydrated cake obtained by dehydrating a slurry containing surface-treated calcium carbonate particles is to be dried, use of a dryer capable of imparting a sufficient amount of heat, such as a conductive heat transfer dryer, makes it possible to improve the uniformity of the surface treatment performed on the surface-treated calcium carbonate particles obtained and increase the Ca conversion rate.

In this manner, it is possible to obtain a surface-treated calcium carbonate filler that contains surface-treated calcium carbonate particles, which have been surface-treated with fatty acids and phosphoric acids, and satisfies the formulae (a), (b), and (c), and optionally (d), (e), and (f).

### 2. Resin Composition

Next, a resin composition according to the present invention will be described below.

The resin composition according to the present invention contains a resin and the above-mentioned surface-treated calcium carbonate filler.

There is no particular limitation on the resin contained in the resin composition, and examples thereof include polyolefin-based resins, polystyrene-based resins, acrylic resins, methacrylic resins, polyvinyl chloride-based resin, polyvinylidene chloride-based resin, polyamide-based resins, polyether-based resins, vinyl acetate-based resins, and polyvinyl alcohol-based resins, and combinations thereof. Also, specific examples of the polyolefin-based resins include polyethylene resins such as low-density polyethylene (LDPE), high-density polyethylene (HDPE), linear low-density polyethylene (L-LDPE), ultra-high-molecular weight polyethylene (UHMWPE), polypropylene resins, ethylene-propylene copolymers, and copolymers of ethylene or propylene and other monomers. The resin may be petroleum-based, plant-based (e.g., a bioplastic), or a combination thereof. In the present invention, the resin is preferably a polyolefin-based resin because the molding temperature is comparatively low compared to engineering plastics or the like, and the resin has sufficient heat resistance to withstand temperatures at which the surface-treated calcium carbonate particles exhibit heat resistance.

The amount of surface-treated calcium carbonate filler contained in the resin composition is not necessarily limited, because the amount of surface-treated calcium carbonate filler in the resin composition varies depending on the types of resins used together, an intended use and desired physical properties of the resulting resin composition, and the like. The amount thereof is 0.05 parts by mass to 100 parts by mass, preferably 50 parts by mass to 100 parts by mass, and more preferably 70 parts by mass to 100 parts by mass with respect to 100 parts by mass of the resin, for example. When the amount of surface-treated calcium carbonate filler contained in the resin composition exceeds 100 parts by mass (i.e., when it exceeds the resin content), the hue (whiteness) may be likely to decrease due to deterioration in kneadability with the resin and resin deterioration. When the amount of surface-treated calcium carbonate filler contained in the resin composition is less than 0.05 parts by mass, the resulting resin composition may not have sufficient heat resistance.

Note that the resin composition according to the present invention may contain, as other additives, lubricants such as fatty acids, fatty acid amides, ethylene bis stearamide, and sorbitan fatty acid esters; plasticizers; stabilizers such as heat stabilizers and light stabilizers; antioxidants; ultraviolet absorbing agents; neutralizing agents; antifogging agents; anti-blocking agents; antistatic agents; slipping agents; and coloring agents; and combinations thereof. There is no particular limitation on the content of the other additives, and an appropriate amount of the other additives may be selected by those skilled in the art within a range in which effects of the surface-treated calcium carbonate filler are not inhibited.

The resin and the surface-treated calcium carbonate filler, and other additives added as needed may be kneaded while being heated, using a means known in the technical field (e.g., a single-screw extruder, a twin-screw extruder, a kneader, or a Banbury mixer), for example.

As a result, the resin composition according to the present invention can be obtained.

The resin composition may be processed into pellets, for example, as a masterbatch. Alternatively, the above resin composition may be used to obtain a later-described molded article as a kneaded resultant.

### 3. Molded Article

A molded article according to the present invention is made of the resin composition.

A porous film having minute pores on its surface can be obtained by forming the resin composition kneaded as described above into a sheet using a T-die or the like, and then uniaxially or biaxially drawing the sheet, for example. Alternatively, it is also possible to obtain a porous film having minute pores on its surface by forming a film using a known molding machine through T-die extrusion, inflation molding, or the like after the above kneading, and subjecting the film to acid treatment to dissolve the surface-treated calcium carbonate filler present inside. Furthermore, if needed, the film may be formed into a multilayer film by stacking multiple T-die extruders in the above process or drawing the film and laminating the films, or in order to impart printing suitability to the film, an ink-receiving layer may be coated by performing surface treatment such as plasma discharge on the film surface.

Thus, the molded article according to the present invention preferably has the form of a film.

### EXAMPLES

Hereinafter, the present invention will be described in detail with reference to Examples, but the present invention is not limited to these Examples. Note that “%” means mass %, and parts means parts by mass in the following description, unless otherwise specified.

Materials, surface-treated calcium carbonate filler, and pellets described in Examples and Comparative Examples were evaluated as follows.

### BET Specific Surface Area of Unmodified Calcium Carbonate

The BET specific surface area (m²/g) of the unmodified calcium carbonate particles was measured by placing 0.2 to 0.3 g of unmodified calcium carbonate particles used in each of Examples and Comparative Examples in a measuring device (Macsorb HM model-1201 manufactured by Mountech Co., Ltd.), performing heat treatment serving as pretreatment at 200 °C for 10 minutes in a mixed gas atmosphere of nitrogen and helium, and performing low-temperature, low-humidity physical adsorption in a liquid nitrogen environment.

### (1) BET Specific Surface Area (Sw) of Surface-Treated Calcium Carbonate Filler

The BET specific surface area (m²/g) of surface treated calcium carbonate particles that constitute the filler was measured by placing 0.2 to 0.3 g of surface-treated calcium carbonate filler obtained in each of the examples and the comparative examples in the measuring device (Macsorb HM model-1201 manufactured by Mountech Co., Ltd.), performing heat treatment serving as pretreatment at 200 °C for 10 minutes in a mixed gas atmosphere of nitrogen and helium, and performing low-temperature, low-humidity physical adsorption in a liquid nitrogen environment.

### (2) Elemental Phosphorus Content (Pw) of Surface-Treated Calcium Carbonate Filler Measured Using Inductively Coupled Plasma (ICP) Emission Spectrometer

In a crucible, 1.0 g of the surface-treated calcium carbonate filler obtained in each of Examples and Comparative Examples was placed, and calcined at 300 °C for 3 hours in an electric furnace. After the calcination, about 60 mL of distilled water and 7.5 mL of 1.38 N nitric acid (nitric acid (1.38) for toxic metal measurement manufactured by Fujifilm Wako Pure Chemical Corporation) were introduced into a beaker containing the mixture, boiled on an electric stove, and slowly cooled. The mixture that was slowly cooled was added to a 100-mL volumetric flask containing 100 μg of yttrium, and the volumetric flask was filled up to 100 mL with distilled water. Then, the mixture was filtered through 5C filter paper, and a sample for ICP measurement was prepared from the obtained filtrate. Thereafter, the sample was used to measure the content (ppm) of elemental phosphorus contained in the sample using an inductively coupled plasma (ICP) emission spectrometer (ICP emission spectrometer SPS3500 manufactured by SII NanoTechnology Inc.).

### (3) Ca Conversion Rate of Surface-Treated Calcium Carbonate Filler

To a 300-mL Erlenmeyer flask, 5.0 g of the surface-treated calcium carbonate filler obtained in each of Examples and Comparative Examples and 80 g of ethanol (95% by volume) were added. Then, the Erlenmeyer flask was immersed in a water bath at 90 °C or more and reflux was performed for 1 hour to extract a surface treatment agent remaining in the surface-treated calcium carbonate particles constituting the filler.

A filtrate was obtained by sufficiently cooling the flask to 20 °C and filtering the contents in the Erlenmeyer flask through suction using a Teflon (registered trademark) filter with a pore size of 0.5 μm or less. The filtrate was placed in a 200-mL dry beaker determined quantitatively, and dried through evaporation on a water bath at 90 °C or higher to remove the solvent. As a result, a residue was obtained, and the mass of the residue was measured. Here, because the mass refers to the mass of a fatty acid and alkali metal salts of the fatty acid in the surface treatment agent in 5.00 g of the surface-treated calcium carbonate particles, the content of the fatty acid and the alkali metal salts of the fatty acid in the surface treatment agent in 1.0 g of the surface-treated calcium carbonate particles was calculated as mass % (X) by multiplying the mass by ⅕.

Note that the content (X) is a numerical value including the mass of alkali metals originating from alkali metal salts of the fatty acid and the like. Therefore, in order to calculate the mass % of a fatty acid and a fatty acid originating from alkali metal salts of the fatty acid, the content of alkali metals (mass %; Y) contained in the surface-treated calcium carbonate particles was measured through atomic absorption spectrometry as follows.

Into a crucible, 1.0 g of the surface-treated calcium carbonate particles were weighed, placed in a muffle furnace (NMF-120 manufactured by Masuda Corporation), calcined at 300 °C for 2 hours, and then cooled to room temperature in a desiccator. Then, the sample was placed in a 200-mL beaker, and 60 mL of distilled water was poured into the beaker. Thereafter, 7.5 mL of 1.38 N nitric acid (nitric acid (1.38) for toxic metal measurement manufactured by Fujifilm Wako Pure Chemical Corporation) was introduced into the beaker, the beaker was covered with a watch glass, and the mixture was boiled using an electric heater. The mixture was cooled at room temperature and introduced into a 100-mL volumetric flask, and the volumetric flask was filled up to 100 mL with distilled water to prepare a measurement sample. The measurement sample obtained in this manner was used to measure the content of alkali metal elements (mass %; Y) using an atomic absorption spectrophotometer (AA-6700F manufactured by Shimadzu Corporation).

The percentage of the mass (g) of a fatty acid that constitutes fatty acid calcium to the total surface treatment amount (g) of the surface-treated calcium carbonate particles (i.e., Ca conversion rate)) was calculated using the following formula, and the content X (mass %), the content Y (mass %), and thermal reduction TG (mass %) per gram of calcium carbonate from 200 °C to 500 °C:

Ca conversion rate (mass %)={(Tg (mass %)−(X (mass %)−Y (mass %))}/TG (mass %)×100

Note that the thermal reduction TG (mass %) per gram of calcium carbonate from 200 °C to 500 °C used to calculate the above Ca conversion rate was measured as follows.

About 30 mg of the surface-treated calcium carbonate filler obtained in each of Examples and Comparative Examples was weighed in a platinum sample pan, and then the thermal reduction of the surface-treated calcium carbonate particles constituting the filler when the temperature was raised from 200 °C to 500 °C at a temperature increase rate of 30 °C/min was measured using, for example, a differential thermal analyzer (DTG-60A manufactured by Shimadzu Corporation), as the thermal reduction TG (mass %) per gram of the surface-treated calcium carbonate.

### (4) D50, Sharpness Index ((D90−D10)/D50), and Da of Surface-Treated Calcium Carbonate Filler

To a 100-mL beaker, 0.3 g of the surface-treated calcium carbonate filler obtained in each of Examples and Comparative Examples and 50 mL of ethanol were added. Then, a sample was obtained by dispersing the content by irradiating the content in the beaker with ultrasonic waves at 300 μA for 60 seconds using an ultrasonic dispersion machine US-300T manufactured by Nihonseiki Kaisha Ltd., for example. Thereafter, the volume particle size distribution of the surface-treated calcium carbonate particles in the sample was measured using a laser diffraction particle size distribution analyzer (MT-3300EX II manufactured by MicrotracBEL Corp.). Based on the results of the obtained volume particle size distribution, values of the D50, D10, D90, and Da, and the sharpness index ((D90−D10)/D50) obtained using the D50, the D10, and the D90 were obtained.

### (5) Thermal Oxidative Stability of Pellets

A test piece was produced using twice-kneaded pellets obtained in each of Examples and Comparative Examples with a mold having a size of 5 cm×5 cm×1 mm thickness and a compression molding machine SFA-37 manufactured by Shinto Metal Industries, Ltd., which was adjusted to 200 °C.

The test piece was heated in air in a forced air oven at 140 °C based on Japanese Industrial Standard JIS K7368 (Plastics-Polypropylene and propylene-copolymers-Determination of thermal oxidative stability in air-Oven method) to accelerate deterioration, and the number of days taken from the start of the test until a local crack, collapse, and/or discoloration was visually observed was recorded and evaluated based on the following.
Excellent: no noticeable changes occurred even after 10 days.
Good: discoloration was observed even after 10 days.
Poor: discoloration and a crack were observed even after 10 days.
Bad: Discoloration and a crack were already observed after 5 days.

### (6) Evaluation of Heat Resistance of Pellets

The pellets obtained in each of Examples and Comparative Examples were heated in air for 10 days using a forced air oven at 140 °C to accelerate deterioration. The melt flow rate (MFR) values (g/10 minutes) of the obtained heat-degraded pellets and pellets in their initial state (not heat-degraded) were measured at 230 °C using a MELT INDEXER F-F01 manufactured by Toyo Seiki Seisaku-sho, Ltd. Furthermore, based on the obtained results, the rate of change (%) in MFR was calculated using the following formula.

$$Rate of Change in MFR ( \% ) = \frac{[ \begin{matrix}MFR of pellets after heat - degraded at \\ 140 ° C . for 10 days ( g / 10 min )\end{matrix} ]}{[ MFR of pellets in initial condition ( g / 10 min ) ]} \times 100 \qquad [ Formula 1 ]$$

### (7) Evaluation of Dispersibility of Pellets

The dispersibility of the pellets obtained in each of the examples and the comparative examples was evaluated based on the following criteria by placing the pellets in a twin-screw kneader (2D25W manufactured by Toyo Seiki Co., Ltd.) equipped with a three-piece strainer having mesh openings of 100 μm, 60 μm, and 400 μm, kneading and extruding the pellets at 180 °C and 150 rpm at a feed rate of 3 kg/hour, and measuring the resin pressure 60 minutes later.
Excellent: the resin pressure 60 minutes after kneading was less than 3 MPa.
Good: the resin pressure 60 minutes after kneading was 3 MPa or more and less than 5 MPa.
Poor: the resin pressure 60 minutes after kneading was 5 MPa or more and less than 8 MPa.
Bad: before 60 minutes passed after kneading, upward bending occurred due to a strainer being clogged.

### Example 1-1: Production of Surface-Treated Calcium Carbonate Filler (E1)

A water slurry containing, in an amount of 10 mass %, precipitated calcium carbonate having a BET specific surface area of 8.0 m²/g was prepared, and the temperature of the slurry was adjusted to 60 °C. A solution obtained by dissolving 0.60 mass % sodium hexametaphosphate (sodium metaphosphate manufactured by Taihei Chemical Industrial Co., Ltd.: chelation value was 125 mg CaCO₃/g) with respect to the solid content of calcium carbonate in an aqueous solution of phosphoric acids dissolved at a concentration of 10 mass % was added to the water slurry, and a solution obtained by dissolving, as fatty acids, 2.20 mass % Nonsal SK-1 (the percentage of saturated fatty acids was 100 mass %) manufactured by NOF CORPORATION, with respect to the solid content of calcium carbonate, in hot water at 70 °C to a concentration of 10 mass %.

Note that the Nonsal SK-1 manufactured by NOF CORPORATION, which was used above, had the following component composition (potassium myristate was 3 mass %, potassium palminate was 27 mass %, potassium stearate was 66 mass %, and the rest was 4 mass %).

Then, stirring was performed at 60 °C for whole day and night for surface treatment, the resulting mixture was dehydrated using a filter press, dried using an instant dryer (air flow dryer Drymeister DMR-1 manufactured by Hosokawa Micron Corporation), and crushed to obtain a surface-treated calcium carbonate filler (E1). The physical property values of the obtained filler (E1) are shown in Tables 1 and 3.

### Example 1-2: Production of Surface-Treated Calcium Carbonate Filler (E2)

A surface-treated calcium carbonate filler (E2) was obtained in the same manner as in Example 1-1, except that an aqueous solution of phosphoric acids in which 0.40 mass % sodium ultraphosphate (Ultraporine manufactured by Taihei Chemical Industrial Co., Ltd.; chelation value was 406 mg CaCO/g) with respect to the solid content of calcium carbonate was dissolved at a concentration of 10% was used instead of the aqueous solution of the phosphoric acids used in Example 1-1, and a CD dryer manufactured by Kurimoto, Ltd. was used as a conductive heat transfer dryer to dry the filler at a steam pressure of 0.25 MPa for 2 hours. The physical property values of the obtained filler (E2) are shown in Tables 1 and 3.

### Example 1-3: Production of Surface-Treated Calcium Carbonate Filler (E3)

A surface-treated calcium carbonate filler (E3) was obtained in the same manner as in Example 1-1, except that an aqueous solution of phosphoric acids in which 0.25 mass % sodium polyphosphate (sodium tripolyphosphate manufactured by Taihei Chemical Industrial Co., Ltd.; chelation value was 130 mg CaCO₃/g) with respect to the solid content of calcium carbonate was dissolved at a concentration of 10 mass % was used instead of the aqueous solution of the phosphoric acids used in Example 1, and a CD dryer manufactured by Kurimoto, Ltd. was used as a conductive heat transfer dryer to dry the filler at a steam pressure of 0.25 MPa for 2 hours. The physical property values of the obtained filler (E3) are shown in Tables 1 and 3.

### Example 1-4: Production of Surface-Treated Calcium Carbonate Filler (E4)

A surface-treated calcium carbonate filler (E4) was obtained in the same manner as in Example 1-1, except that an aqueous solution of phosphoric acids in which 0.20 mass % potassium pyrophosphate (manufactured by RASA Industries, Ltd.; chelation value was 50 mg CaCO₃/g) with respect to the solid content of calcium carbonate was dissolved at a concentration of 10 mass % was used instead of the aqueous solution of the phosphoric acids used in Example 1-1, and a CD dryer manufactured by Kurimoto, Ltd. was used as a conductive heat transfer dryer to dry the filler at a steam pressure of 0.25 MPa for 2 hours. The physical property values of the obtained filler (E4) are shown in Tables 1 and 3.

### Example 1-5: Production of Surface-Treated Calcium Carbonate Filler (E5)

A surface-treated calcium carbonate filler (E5) was obtained in the same manner as in Example 1-1, except that an aqueous solution of phosphoric acids in which 1.50 mass % orthophosphoric acid (75% phosphoric acid manufactured by RASA Industries, Ltd.; chelation value was 0 mg CaCO₃/g) as pure content with respect to the solid content of calcium carbonate was dissolved at a concentration of 10 mass % was used instead of the aqueous solution of the phosphoric acids used in Example 1-1, 1.60 mass % Lauric acid 50 (the percentage of saturated fatty acids was 84%) manufactured by Miyoshi Oil & Fat Co., Ltd. with respect to the solid content of calcium carbonate was dissolved in hot water at 70 °C to a concentration of 10% and saponified with an equivalent amount of sodium hydroxide, the resulting fatty acids were used instead of the fatty acids used in Example 1-1, stirring was performed at 60 °C for 4 hours for surface treatment, and a CD dryer manufactured by Kurimoto, Ltd. was used as a conductive heat transfer dryer to dry the filler at a steam pressure of 0.25 MPa for 2 hours. The physical property values of the obtained filler (E5) are shown in Tables 1 and 3.

Note that the Lauric acid 50 manufactured by Miyoshi Oil & Fat Co., Ltd. used above had the following component composition (the percentage of lauric acid was 54 mass %, the percentage of myristic acid was 17 mass %, the percentage of palmitic acid was 10 mass %, the percentage of stearic acid was 2 mass %, the percentage of oleic acid was 14 mass %, and rest was 3 mass %).

### Example 1-6: Production of Surface-Treated Calcium Carbonate Filler (E6)

A surface-treated calcium carbonate filler (E6) was obtained in the same manner as in Example 1-1, except that an aqueous solution of phosphoric acids in which 1.80 mass % aluminum monophosphate (manufactured by Taihei Chemical Industrial Co., Ltd.; chelation value was 0 mg CaCO₃/g) with respect to the solid content of calcium carbonate was dissolved at a concentration of 10 mass % was used instead of the aqueous solution of the phosphoric acids used in Example 1-1, 1.60 mass % Lauric acid NAAR-122 (the percentage of saturated fatty acids was 100%) manufactured by NOF CORPORATION with respect to the solid content of calcium carbonate was dissolved in hot water at 70 °C to a concentration of 10% and saponified with an equivalent amount of sodium hydroxide, the resulting fatty acids were used instead of the fatty acids used in Example 1-1, and a CD dryer manufactured by Kurimoto, Ltd. was used as a conductive heat transfer dryer to dry the filler at a steam pressure of 0.25 MPa for 2 hours. The physical property values of the obtained filler (E6) are shown in Tables 1 and 3.

### Example 1-7: Production of Surface-Treated Calcium Carbonate Filler (E7)

A surface-treated calcium carbonate filler (E7) was obtained in the same manner as in Example 1-1, except that an aqueous solution of phosphoric acids in which 0.30 mass % nitrilotrismethylenephosphonic acid (PH320 manufactured by Chelest Corporation; chelation value was 200 mg CaCO₃/g) with respect to the solid content of calcium carbonate was dissolved at a concentration of 10 mass % was used instead of the aqueous solution of the phosphoric acids used in Example 1-1, 1.60 mass % Lauric acid NAAR-122 (the percentage of saturated fatty acids was 100%) manufactured by NOF CORPORATION with respect to the solid content of calcium carbonate and a 0.03 mass % emulsifier (HITENOL NF-08 manufactured by DKS Co., Ltd.) with respect to the solid content of calcium carbonate were dissolved in hot water at 70 °C to a total concentration of 10 mass % and emulsified using a T.K. ROBOMIX (HOMO MIXER MARK II manufactured by Tokushu Kika Kogyo Co., Ltd.) at 10000 rpm for 5 minutes, the resulting mixture was used instead of the fatty acids used in Example 1-1, and a CD dryer manufactured by Kurimoto, Ltd. was used as a conductive heat transfer dryer to dry the filler at a steam pressure of 0.25 MPa for 2 hours. The physical property values of the obtained filler (E7) are shown in Tables 1 and 3.

### Example 1-8: Production of Surface-Treated Calcium Carbonate Filler (E8)

A surface-treated calcium carbonate filler (E8) was produced in the same manner as in Example 1-1, except that a water slurry containing, in an amount of 10 mass %, precipitated calcium carbonate having a BET specific surface area of 13.0 m²/g was prepared, and the temperature of the slurry was adjusted to 60 °C. An aqueous solution of phosphoric acids in which 1.00 mass % sodium hexametaphosphate (sodium metaphosphate manufactured by Taihei Chemical Industrial Co., Ltd.: chelation value was 125 mg CaCO₃/g) with respect to the solid content of calcium carbonate was dissolved at a concentration of 10 mass % was added to the water slurry, and a 3.00% Nonsal SK-1 (the percentage of saturated fatty acids was 100%) manufactured by NOF CORPORATION, with respect to the solid content of calcium carbonate dissolved in hot water at 70 °C to a concentration of 10% was added as the fatty acids. The physical property values of the obtained filler (E8) are shown in Tables 1 and 3.

### Example 1-9: Production of Surface-Treated Calcium Carbonate Filler (E9)

A surface-treated calcium carbonate filler (E9) was obtained in the same manner as in Example 1-8, except that an aqueous solution of phosphoric acids in which 1.00 mass % sodium ultraphosphate (Ultraporine manufactured by Taihei Chemical Industrial Co., Ltd.; chelation value was 406 mg CaCO/g) with respect to the solid content of calcium carbonate was dissolved at a concentration of 10% was used instead of the aqueous solution of the phosphoric acids used in Example 1-8, 2.20 mass % Lauric acid NAAR-122 (the percentage of saturated fatty acids was 100%) manufactured by NOF CORPORATION with respect to the solid content of calcium carbonate was dissolved in hot water at 70 °C to a concentration of 10 mass % and saponified with an equivalent amount of sodium hydroxide, the resulting fatty acids were used instead of the fatty acids used in Example 1-8, stirring was performed at 60 °C for 4 hours for surface treatment, the resulting mixture was dehydrated using a filter press, and a CD dryer manufactured by Kurimoto, Ltd. was used as a conductive heat transfer dryer to dry the filler at a steam pressure of 0.25 MPa for 2 hours. The physical property values of the obtained filler (E9) are shown in Tables 1 and 3.

### Example 1-10: Production of Surface-Treated Calcium Carbonate Filler (E10)

A water slurry containing, in an amount of 10 mass %, precipitated calcium carbonate having a BET specific surface area of 16.8 m²/g was prepared, and the temperature of the slurry was adjusted to 60 °C. A surface-treated calcium carbonate filler (E10) was obtained in the same manner as in Example 1-8, except that an aqueous solution of phosphoric acids in which 1.20 mass % sodium ultraphosphate (Ultraporine manufactured by Taihei Chemical Industrial Co., Ltd.; chelation value was 406 mg CaCO₃/g) with respect to the solid content of calcium carbonate was dissolved at a concentration of 10% was added to the water slurry, and a 4.00 mass % Nonsal SK-1 (the percentage of saturated fatty acids was 100%) manufactured by NOF CORPORATION, with respect to the solid content of calcium carbonate dissolved in hot water at 70 °C to a concentration of 10% was added as the fatty acids. The physical property values of the obtained filler (E10) are shown in Tables 1 and 3.

### Example 1-11: Production of Surface-Treated Calcium Carbonate Filler (E11)

A surface-treated calcium carbonate filler (E11) was obtained in the same manner as in Example 1-10, except that 1.20 mass % sodium hexametaphosphate (sodium metaphosphate manufactured by Taihei Chemical Industrial Co., Ltd.: chelation value was 125 mg CaCO₃/g) with respect to the solid content of calcium carbonate was dissolved at a concentration of 10% was used instead of the aqueous solution of phosphoric acids used in Example 1-10, and stirring was performed at 80 °C for 6 hours for surface treatment, the resulting mixture was dehydrated using a filter press, and a CD dryer manufactured by Kurimoto, Ltd. was used as a conductive heat transfer dryer to dry the filler at a steam pressure of 0.25 MPa for 2 hours. The physical property values of the obtained filler (E11) are shown in Tables 1 and 3.

### Example 1-12: Production of Surface-Treated Calcium Carbonate Filler (E12)

A surface-treated calcium carbonate filler (E12) was obtained in the same manner as in Example 1-11, except that 4.00 mass % mixed fatty acid salt B (the percentage of saturated fatty acids was 92%), with respect to the solid content of calcium carbonate, prepared to have the following composition was dissolved as a fatty acid salt in hot water at 70 °C to a concentration of 10% and the resulting solution was used instead of the aqueous solution of phosphoric acids used in Example 1-11, and an instant dryer (air flow dryer Drymeister DMR-1 manufactured by Hosokawa Micron Corporation) was used. The physical property values of the obtained filler (E12) are shown in Tables 2 and 4.

Note that the mixed fatty acid salt B used above had the following component composition (the percentage of sodium laurate was 10 mass %, the percentage of sodium myristate was 2 mass %, the percentage of sodium palmitate was 20 mass %, the percentage of potassium stearate was 60 mass %, and the percentage of sodium oleate was 8 mass %).

### Comparative Example 1-1: Production of Surface-Treated Calcium Carbonate Filler (C1)

A surface-treated calcium carbonate filler (C1) was obtained in the same manner as in Example 1-12, except that stirring was performed at 80 °C for 30 minutes for surface treatment. The physical property values of the obtained filler (C1) are shown in Tables 2 and 4.

### Comparative Example 1-2: Production of Surface-Treated Calcium Carbonate Filler (C2)

A surface-treated calcium carbonate filler (C2) was obtained in the same manner as in Example 1-12, except that stirring was performed at 60 °C for 4 hours for surface treatment. The physical property values of the obtained filler (C2) are shown in Tables 2 and 4.

### Comparative Example 1-3: Production of Surface-Treated Calcium Carbonate Filler (C3)

A surface-treated calcium carbonate filler (C3) was obtained in the same manner as in Example 1-11, except that an aqueous solution of phosphoric acids in which 3.60 mass % sodium hexametaphosphate (sodium metaphosphate manufactured by Taihei Chemical Industrial Co., Ltd.: chelation value was 125 mg CaCO₃/g) with respect to the solid content of calcium carbonate was dissolved at a concentration of 10 mass % was used instead of the aqueous solution of the phosphoric acids used in Example 1-11. The physical property values of the obtained filler (C3) are shown in Tables 2 and 4.

### Comparative Example 1-4: Production of Surface-Treated Calcium Carbonate Filler (C4)

A surface-treated calcium carbonate filler (C4) was obtained in the same manner as in Example 1-11, except that no aqueous solution of phosphoric acids was added. The physical property values of the obtained filler (C4) are shown in Tables 2 and 4.

### Comparative Example 1-5: Production of Surface-Treated Calcium Carbonate Filler (C5)

A surface-treated calcium carbonate filler (C5) was obtained in the same manner as in Example 1-11 in the same manner as in Example 1-11, except that an aqueous solution of phosphoric acids in which 0.30 mass % nitrilotrismethylenephosphonic acid (PH320 manufactured by Chelest Corporation: chelation value was 200 mg CaCO₃/g) with respect to the solid content of calcium carbonate was dissolved at a concentration of 10% was used instead of the aqueous solution of phosphoric acids used in Example 1-11, a 2.00 mass % stearic acid cherry (the percentage of saturated fatty acids was 100%) manufactured by NOF CORPORATION with respect to the solid content of calcium carbonate and 0.03 mass % emulsifier (HITENOL NF-08 manufactured by DKS Co., Ltd.) with respect to the solid content of calcium carbonate were dissolved in hot water at 80 °C to a total concentration of 10 mass % and emulsified using the T.K. ROBOMIX (HOMO MIXER MARK II manufactured by Tokushu Kika Kogyo Co., Ltd.) at 10000 rpm for 5 minutes, the resulting mixture was used instead of the fatty acids used in Example 1-11, and stirring was performed at 90 °C for whole day and night for surface treatment. The physical property values of the obtained filler (C5) are shown in Tables 2 and 4.

Note that the stearic acid cherry manufactured by NOF CORPORATION used above had the following component composition (the percentage of myristic acid was 2 mass %, the percentage of palmitic acid was 31 mass %, and the percentage of stearic acid was 66 mass %, and the percentage of the rest was 1 mass %).

### Example 1-13: Production of Surface-Treated Calcium Carbonate Filler (E13)

A water slurry containing precipitated calcium carbonate having a BET specific surface area of 20.5 m²/g in an amount of 10 mass % was prepared, and the temperature of the slurry was adjusted to 60 °C. An aqueous solution of phosphoric acids in which 3.00 mass % sodium hexametaphosphate (sodium metaphosphate manufactured by Taihei Chemical Industrial Co., Ltd.: chelation value was 125 mg CaCO₃/g) with respect to the solid content of calcium carbonate was dissolved at a concentration of 10 mass % was added to the water slurry, and 5.00 mass % Nonsal SK-1 manufactured by NOF CORPORATION (the percentage of fatty acids was 100%) with respect to the solid content of calcium carbonate dissolved in hot water at 70 °C to have a concentration of 10% was added as a fatty acid salt. Then, a surface-treated calcium carbonate filler (E13) was obtained by stirring the resulting mixture at 60 °C for whole day and night for surface treatment and dehydrating the mixture using a filter press, and drying the mixture at a steam pressure of 0.25 MPa for 2 hours using a CD dryer manufactured by Kurimoto, Ltd. as a conductive heat transfer dryer, and crushing the dried mixture. The physical property values of the obtained filler (E13) are shown in Tables 2 and 4.

### Comparative Example 1-6: Production of Surface-Treated Calcium Carbonate Filler (C6)

An aqueous solution of phosphoric acids in which 0.20 mass % sodium hexametaphosphate (sodium metaphosphate manufactured by Taihei Chemical Industrial Co., Ltd.: chelation value was 125 mg CaCO/g) with respect to the solid content of calcium carbonate was dissolved at a concentration of 10% was added while heavy calcium carbonate (Super #2000 manufactured by Maruo Calcium Co., Ltd.) having a BET specific surface area of 2.0 m²/g was being stirred using a Henschel mixer, and 1.00 mass % stearic acid cherry (the percentage of fatty acids was 100%) manufactured by NOF CORPORATION with respect to the solid content of calcium carbonate was added as a fatty acid. Then, a surface-treated calcium carbonate filler (C6) was obtained by stirring the resulting mixture at 110 °C for 30 minutes for surface treatment to evaporate water. The physical property values of the obtained filler (C6) are shown in Tables 2 and 4.

### Comparative Example 1-7: Production of Surface-Treated Calcium Carbonate Filler (C7)

A water slurry containing precipitated calcium carbonate having a BET specific surface area of 28.0 m²/g in an amount of 10 mass % was prepared, and the temperature of the slurry was adjusted to 60 °C. An aqueous solution of phosphoric acids in which 1.20 mass % sodium hexametaphosphate (sodium metaphosphate manufactured by Taihei Chemical Industrial Co., Ltd.: chelation value was 125 mg CaCO₃/g) with respect to the solid content of calcium carbonate was dissolved at a concentration of 10% was added to the water slurry, and 7.00 mass % Nonsal SK-1 (the percentage of saturated fatty acids was 100%) manufactured by NOF CORPORATION with respect to the solid content of calcium carbonate was dissolved in hot water at 70 °C to a concentration of 10%, and the resulting mixture was used as a fatty acid salt. Then, a surface-treated calcium carbonate filler (C7) was obtained by stirring the resulting mixture at 60 °C for whole day and night for surface treatment and dehydrating the mixture using a filter press, and drying the mixture at a steam pressure of 0.25 MPa for 2 hours using a CD dryer manufactured by Kurimoto, Ltd. as a conductive heat transfer dryer, and crushing the dried mixture. The physical property values of the obtained filler (C7) are shown in Tables 2 and 4.

TABLE 1

| | | Example | Example | Example | Example | Example | Example |
|---|---|---|---|---|---|---|---|
| | | 1-1 | 1-2 | 1-3 | 1-4 | 1-5 | 1-6 |
| Filler Name | | E1 | E2 | E3 | E4 | E5 | E6 |
| BET Specific Surface Area | | 8.0 | 8.0 | 8.0 | 8.0 | 8.0 | 8.0 |
| of Unmodified Calcium | | | | | | | |
| Carbonate(m²/g) | | | | | | | |
| Phosphoric | Type | Sodium | Sodium | Sodium | Sodium | Orthophosphoric | Aluminum |
| Acids | | Hexameta- | Ultra- | Polyphosphate | Pyrophosphate | acid | Phosphate |
| | | phosphate | phosphate | | | | |
| | Chelation | 125 | 406 | 130 | 50 | 0 | 0 |
| | Amount of | 0.60% | 0.40% | 0.25% | 0.20% | 1.50% | 1.80% |
| | Addition | | | | | | |
| Fatty Acids | C12 | — | — | — | — | 54% | 100% |
| | C14 | 3% | 3% | 3% | 3% | 17% | — |
| | C16 | 27% | 27% | 27% | 27% | 10% | — |
| | C18 | 66% | 66% | 66% | 66% | 2% | — |
| | C18F1 | — | — | — | — | 14% | — |
| | Other | 4% | 4% | 4% | 4% | 3% | — |
| | Saturated | 100% | 100% | 100% | 100% | 84% | 100% |
| | Fatty Acid | | | | | | |
| | Amount of | 2.20% | 2.20% | 2.20% | 2.20% | 1.60% | 1.60% |
| | Addition | | | | | | |
| Processing | Temperature | 60 °C | 60 °C | 60 °C | 60 °C | 60 °C | 60 °C |
| Conditions | Time | Whole Day | Whole Day | Whole Day | Whole Day | 4 | Whole Day |
| | | and Night | and Night | and Night | and Night | Hours | and Night |
| Drying | Dryer Type | Instant | Conductive | Conductive | Conductive | Conductive | Conductive |
| Conditions | | Dryer | Heat | Heat | Heat | Heat | Heat |
| | | | Transfer | Transfer | Transfer | Transfer | Transfer |

| | | Example | Example | Example | Example | Example |
|---|---|---|---|---|---|---|
| | | 1-7 | 1-8 | 1-9 | 1-10 | 1-11 |
| Filler Name | | E7 | E8 | E9 | E10 | E11 |
| BET Specific Surface Area | | 8.0 | 13.0 | 13.0 | 16.8 | 16.8 |
| of Unmodified Calcium | | | | | | |
| Carbonate(m²/g) | | | | | | |
| Phosphoric | Type | Nitrilotrimethylene | Sodium | Sodium | Sodium | Sodium |
| Acids | | Sulfonic Acid | Hexameta- | Ultra- | Ultra- | Hexameta- |
| | | | phosphate | phosphate | phosphate | phosphate |
| | Chelation | 200 | 125 | 406 | 406 | 125 |
| | Amount of | 0.30% | 1.00% | 1.00% | 1.20% | 1.20% |
| | Addition | | | | | |
| Fatty Acids | C12 | 100% | — | 100% | — | — |
| | C14 | — | 3% | — | 3% | 3% |
| | C16 | — | 27% | — | 27% | 27% |
| | C18 | — | 66% | — | 66% | 66% |
| | C18F1 | — | — | — | — | — |
| | Other | — | 4% | — | 4% | 4% |
| | Saturated | 100% | 100% | 100% | 100% | 100% |
| | Fatty Acid | | | | | |
| | Amount of | 1.60% | 3.00% | 2.20% | 4.00% | 4.00% |
| | Addition | | | | | |
| Processing | Temperature | 60 °C | 60 °C | 60 °C | 60 °C | 80 °C |
| Conditions | Time | Whole Day | Whole Day | 4 | Whole Day | 6 |
| | | and Night | and Night | Hours | and Night | Hours |
| Drying | Dryer Type | Conductive | Instant | Conductive | Instant | Conductive |
| Conditions | | Heat | Dryer | Heat | Dryer | Heat |
| | | Transfer | | Transfer | | Transfer |

In the table, “%” represents “mass %”; C12 represents the content of lauric acid (salt) (%); C14 represents the content of myristic acid (salt) (mass %);
C16 represents the content of palmitic acid (salt)(mass %); C18 represents the content of stearic acid (salt) (mass %); and C18F1 represents the content of oleic acid (salt) (mass %).

TABLE 2

| | | | Comparative | Comparative | Comparative | Comparative |
|---|---|---|---|---|---|---|
| | | Example | Example | Example | Example | Example |
| | | 1-12 | 1-1 | 1-2 | 1-3 | 1-4 |
| Filler Name | | E12 | C1 | C2 | C3 | C4 |
| BET Specific Surface Area | | 16.8 | 16.8 | 16.8 | 16.8 | 16.8 |
| of Unmodified Calcium | | | | | | |
| Carbonate(m²/g) | | | | | | |
| Phosphoric | Type | Sodium | Sodium | Sodium | Sodium | None |
| Acids | | Hexameta- | Hexameta- | Hexameta- | Hexameta- | |
| | | phosphate | phosphate | phosphate | phosphate | |
| | Chelation | 125 | 125 | 125 | 125 | — |
| | Amount of | 1.20% | 1.20% | 1.20% | 3.60% | — |
| | Addition | | | | | |
| Fatty Acids | C12 | 10% | 10% | 10% | — | — |
| | C14 | 2% | 2% | 2% | 3% | 3% |
| | C16 | 20% | 20% | 20% | 27% | 27% |
| | C18 | 60% | 60% | 60% | 66% | 66% |
| | C18F1 | 8% | 8% | 8% | — | — |
| | Other | — | — | — | 4% | 4% |
| | Saturated | 92% | 92% | 92% | 100% | 100% |
| | Fatty Acid | | | | | |
| | Amount of | 4.00% | 4.00% | 4.00% | 4.00% | 4.00% |
| | Addition | | | | | |
| Processing | Temperature | 80 °C | 80 °C | 60 °C | 80 °C | 80 °C |
| Conditions | Time | 6 | 30 | 4 | 6 | 6 |
| | | Hours | Minites | Hours | Hours | Hours |
| Drying | Dryer Type | Instant | Instant | Instant | Conductive | Conductive |
| Conditions | | Dryer | Dryer | Dryer | Heat Transfer | Heat Transfer |

| | | Comparative | | Comprative | Comparative |
|---|---|---|---|---|---|
| | | Example | Example | Example | Example |
| | | 1-5 | 1-13 | 1-6 | 1-7 |
| Filler Name | | C5 | E13 | C6 | C7 |
| BET Specific Surface Area | | 16.8 | 20.5 | 2.0 | 28.0 |
| of Unmodified Calcium | | | | | |
| Carbonate(m²/g) | | | | | |
| Phosphoric | Type | Nitrilotrimethylene | Sodium | Sodium | Sodium |
| Acids | | Phosphonic | Hexameta- | Hexameta- | Hexameta- |
| | | Acid | phosphate | phosphate | phosphate |
| | Chelation | 200 | 125 | 125 | 125 |
| | Amount of | 0.30% | 3.00% | 0.20% | 1.20% |
| | Addition | | | | |
| Fatty Acids | C12 | — | — | — | |
| | C14 | 2% | 3% | 2% | 3% |
| | C16 | 31% | 27% | 31% | 27% |
| | C18 | 66% | 66% | 66% | 66% |
| | C18F1 | — | — | — | — |
| | Other | 1% | 4% | 1% | — |
| | Saturated | 100% | 100% | 100% | 100% |
| | Fatty Acid | | | | |
| | Amount of | 2.00% | 5.00% | 1.00% | 7.00% |
| | Addition | | | | |
| Processing | Temperature | 90 °C | 60 °C | 105 °C | 60 °C |
| Conditions | Time | Whole Day | Whole Day | 30 | Whole Day |
| | | and Night | and Night | Minutes | and Night |
| Drying | Dryer Type | Conductive | Conductive | — | Conductive |
| Conditions | | Heat Transfer | Heat Transfer | | Heat Transfer |

In the table, “%” represents “mass %”; C12 represents the content of lauric acid (salt) (%); C14 represents the content of myristic acid (salt) (mass %);
C16 represents the content of palmitic acid (salt) (mass %); C18 represents the content of stearic acid (salt) (mass %); and C18F1 represents the content of oleic acid (salt) (mass %).

TABLE 3

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple | ple | ple | ple | ple | ple | ple | ple | ple | ple | ple |
| | | 1-1 | 1-2 | 1-3 | 1-4 | 1-5 | 1-6 | 1-7 | 1-8 | 1-9 | 1-10 | 1-11 |
| Filler Name | | E1 | E2 | E3 | E4 | E5 | E6 | E7 | E8 | E9 | E10 | E11 |
| (a) | Sw(m²/g) | 6.8 | 6.8 | 6.7 | 6.6 | 7.0 | 7.0 | 6.9 | 11 | 11.5 | 13.8 | 13.6 |
| (b) | Pw(ppm) | 980 | 650 | 460 | 340 | 4480 | 3060 | 600 | 1580 | 1610 | 1840 | 1780 |
| (c) | Ca Conversion | 64 | 74 | 57 | 52 | 52 | 57 | 82 | 61 | 66 | 55 | 57 |
| | Rate(%) | | | | | | | | | | | |
| (d) | D50(μm) | 0.52 | 0.51 | 0.6 | 0.6 | 0.88 | 0.64 | 0.43 | 0.34 | 0.4 | 0.45 | 0.35 |
| (e) | (D90 − D10)/D50 | 1.58 | 1.59 | 1.72 | 1.77 | 2.22 | 1.91 | 1.28 | 1.85 | 1.8 | 2.18 | 1.86 |
| (f) | Da(μm) | 3.27 | 3.27 | 3.89 | 3.89 | 6 | 5.04 | 2.31 | 2.12 | 2.52 | 5.04 | 4.63 |

TABLE 4

| | | | Comparative | Comparative | Comparative | Comparative | Comparative | | Comparative | Comprative |
|---|---|---|---|---|---|---|---|---|---|---|
| | | Example | Example | Example | Example | Example | Example | Example | Example | Example |
| | | 1-12 | 1-1 | 1-2 | 1-3 | 1-4 | 1-5 | 1-13 | 1-6 | 1-7 |
| Filler Name | | E12 | C1 | C2 | C3 | C4 | C5 | E13 | C6 | C7 |
| (a) | Sw(m²/g) | 14.0 | 13.8 | 13.8 | 14.2 | 13.8 | 14.5 | 17.0 | 1.8 | 22.0 |
| (b) | Pw(ppm) | 1800 | 1680 | 1720 | 5740 | 22 | 590 | 4580 | 620 | 1740 |
| (c) | Ca Conversion | 52 | 43 | 40 | 42 | 72 | 96 | 52 | 52 | 56 |
| | Rate (%) | | | | | | | | | |
| (d) | D50(μm) | 0.25 | 0.33 | 0.41 | 1 | 0.34 | 2.88 | 2.36 | 1.87 | 5.17 |
| (e) | (D90 − D10)/D50 | 1.6 | 1.76 | 1.43 | 2.36 | 1.91 | 2.28 | 1.99 | 1.77 | 3.21 |
| (f) | Da(μm) | 3 | 2.31 | 2.31 | 7.13 | 3.44 | 15.56 | 9.25 | 9.25 | 44 |

### Examples 2-1 to 2-13 and Comparative Examples 2-1 To 2-7: Production of Twice-Kneaded Pellets (NE1) to (NE13) and (NC1) to (NC7)

Coarse pellets were produced by introducing 10 kg of a resin mixture obtained by mixing 30 parts by mass of the surface-treated calcium carbonate filler produced in each of Examples 1-1 to 1-13 and Comparative Examples 1-1 to 1-7 and 70 parts by mass of polypropylene resin (NOVATEC PP FB3B manufactured by Japan Polypropylene Corporation, MFR7.5) into a twin-screw kneader (2D25W manufactured by Toyo Seiki Co., Ltd.) equipped with a strainer having a mesh opening of 100 μm, kneading and extruding the resin mixture at 180 °C and 150 rpm at a feed rate of 3 kg/hour, and cutting the extruded mixture using a pelletizer. Furthermore, twice-kneaded pellets (NE1) to (NE13) to (NC1) to (NC7) were obtained by drying the corresponding coarse pellets at 60 °C for whole day and night, kneading and drying the pellets under the same conditions.

Tables 5 and 6 show results of evaluation of the obtained twice-kneaded pellets (NE1) to (NE13) and (NC1) to (NC7).

TABLE 5

| | | Exam- | Exam- | Exam- | Exam- | Exam- | Exam- | Exam- | Exam- | Exam- | Exam- | Exam- |
|---|---|---|---|---|---|---|---|---|---|---|---|---|
| | | ple | ple | ple | ple | ple | ple | ple | ple | ple | ple | ple |
| | | 2-1 | 2-2 | 2-3 | 2-4 | 2-5 | 2-6 | 2-7 | 2-8 | 2-9 | 2-10 | 2-11 |
| Pellet Name | | NE1 | NE2 | NE3 | NE4 | NE5 | NE6 | NE7 | NE8 | NE9 | NE10 | NE11 |
| Name of Filler Used | | E1 | E2 | E3 | E4 | E5 | E6 | E7 | E8 | E9 | E10 | E11 |
| Thermal Oxidative Stability | | Excellent | Excellent | Good | Poor | Poor | Good | Good | Good | Good | Good | Good |
| Heat | MFR in Initial | 9 | 9 | 9 | 8 | 9 | 8 | 9 | 9 | 9 | 11 | 10 |
| Resistance | Condition | | | | | | | | | | | |
| Test | (g/10 min) | | | | | | | | | | | |
| | MFR after | 11 | 12 | 15 | 25 | 25 | 15 | 14 | 15 | 14 | 18 | 17 |
| | 10 Days | | | | | | | | | | | |
| | (g/10 min) | | | | | | | | | | | |
| | Rate of Change | 122% | 133% | 167% | 313% | 278% | 188% | 156% | 167% | 156% | 164% | 170% |

| | | | | | | | | | | | |
|---|---|---|---|---|---|---|---|---|---|---|---|
| Dispersibility Evaluation | Excellent | Excellent | Good | Good | Poor | Poor | Excellent | Excellent | Excellent | Poor | Poor |

TABLE 6

| | | | Compar- | Compar- | Compar- | Compar- | Compar- | | Compar- | Compar- |
|---|---|---|---|---|---|---|---|---|---|---|
| | | | ative | ative | ative | ative | ative | | ative | ative |
| | | Exam- | Exam- | Exam- | Exam- | Exam- | Exam- | Exam- | Exam- | Exam- |
| | | ple | ple | ple | ple | ple | ple | ple | ple | ple |
| | | 2-12 | 2-1 | 2-2 | 2-3 | 2-4 | 2-5 | 2-13 | 2-6 | 2-7 |
| Pellet Name | | NE12 | NC1 | NC2 | NC3 | NC4 | NC5 | NE13 | NC6 | NC7 |
| Name of Filler Used | | E12 | C1 | C2 | C3 | C4 | C5 | E13 | C6 | C7 |
| Thermal Oxidative Stability | | Poor | Bad | Bad | Bad | Bad | Good | Poor | Bad | Poor |
| Heat | MFR in Initial | 10 | 10 | 10 | 10 | 10 | 8 | 10 | 12 | 13 |
| Resistance | Condition | | | | | | | | | |
| Test | (g/10 min) | | | | | | | | | |
| | MFR after 10 | 25 | 100 (Upper | 100 (Upper | 100 (Upper | 100 (Upper | 100 (Upper | 33 | 100 (Upper | 42 |
| | Days (g/10 min) | | Limit) | Limit) | Limit) | Limit) | Limit) | | Limit) | |
| | Rate of Change | 250% | 1000% | 1000% or | 1000% or | 1000% or | 1000% or | 330% | 830% or | 382% |
| | | | | More | More | More | More | | More | |

| | | | | | | | | | |
|---|---|---|---|---|---|---|---|---|---|
| Dispersibility Evaluation | Good | Good | Good | Poor | Good | Bad | Poor | Poor | Bad |

As shown in Tables 5 and 6, the twice-kneaded pellets (NE1) to (NE13) produced in Examples 2-1 to 2-13 had the same or higher thermal oxidation stability, compared to the twice-kneaded pellets (NC1) to (NC7) of Comparative Examples 2-1 to 2-7, and the rate of change in heat resistance tests was kept relatively low. Also, regarding the results of dispersibility evaluation, the pellets (NE1) to (NE13) of Examples 2-1 to 2-13 had the same or better dispersibility, compared to the pellets (NC1) to (NC7) of Comparative Examples 2-1 to 2-7.

Therefore, the surface-treated calcium carbonate fillers (E1) to (E13) produced in Examples 1-1 to 1-13 and used for the twice-kneaded pellets (NE1) to (NE13) produced in Examples 2-1 to 2-13 had better stability and heat resistance than the surface-treated calcium carbonate fillers (C1) to (C7) of Comparative Examples 2-1 to 2-7 used in the twice-kneaded pellets (NC1) to (NC7) of Comparative Examples 2-1 to 2-7, and had the property of being sufficiently and uniformly dispersed.

### INDUSTRIAL APPLICABILITY

The present invention is useful in, for example, the field of resin molding, the field of architecture and housing, the field of paints, and a wide range of technical fields related thereto.

What is claimed is:

1. A surface-treated calcium carbonate filler comprising surface-treated calcium carbonate particles that have been surface-treated using fatty acids and phosphoric acids, formulae (a), (b), and (c) below being satisfied:
3≤Sw≤20 (m²/g); (a)
300≤Pw≤5000 (ppm); and (b)
50≤Ca conversion rate≤95 (mass %), (c)
where the Sw is a BET specific surface area (m²/g) of the surface-treated calcium carbonate particles,
the Pw is an elemental phosphorus content (ppm) in the surface-treated calcium carbonate particles measured using an inductively coupled plasma (ICP) emission spectrometer, and
the Ca conversion rate is a percentage of the mass (g) of a fatty acid constituting fatty acid calcium relative to a total surface treatment amount (g) of the surface-treated calcium carbonate particles.

2. The surface-treated calcium carbonate filler according to claim 1, wherein formulae (d), (e), and (f) below are further satisfied:
0.1≤D50≤1.5 (μm); (d)
0.9≤(D90−D10)/D50≤2.0; and (e)
Da≤5.0 (μm), (f)
where D50 is a 50% diameter (μm) cumulated from a small particle side in a volume particle size distribution of the surface-treated calcium carbonate particles measured using a laser diffraction particle size distribution analyzer,
D90 is a 90% diameter (μm) cumulated from the small particle side in the volume particle size distribution of the surface-treated calcium carbonate particles measured using the laser diffraction particle size distribution analyzer,
D10 is a 10% diameter (μm) cumulated from the small particle side in the volume particle size distribution of the surface-treated calcium carbonate particles measured using the laser diffraction particle size distribution analyzer, and
Da is the maximum particle diameter (μm) in the volume particle size distribution of the surface-treated calcium carbonate particles measured using the laser diffraction particle size distribution analyzer.

3. The surface-treated calcium carbonate filler according to claim 1, wherein the fatty acids are at least one compound selected from the group consisting of saturated fatty acids and saturated fatty acid salts.

4. The surface-treated calcium carbonate filler according to claim 1, to be used to form a polyolefin-based resin composition.

5. A resin composition comprising a resin, and the surface-treated calcium carbonate filler according to claim 1.

6. The resin composition according to claim 5, wherein the resin is a polyolefin-based resin.

7. A molded article comprising the resin composition according to claim 5.

8. The molded article according to claim 7, wherein the molded article has a film form.
